(19) United States
(12) Patent Application Publication
(10) Pub. No.: US 2007/0269229 A1
(43) Pub. Date: Nov. 22, 2007

(54) FIXING APPARATUS AND IMAGE FORMING APPARATUS

(75) Inventors: Yoritsugu MAEDA, Toride-shi (JP); Hiromichi TSUJINO, Moriya-shi (JP); Katsumi TAKAHASHI, Toride-shi (JP); Junichi NOGUCHI, Suzhou (CN); Eijiro ATARASHI, Toride-shi (JP); Takashi SOYA, Arakawa-ku (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/743,871

(22) Filed: May 3, 2007

(30) Foreign Application Priority Data
May 16, 2006 (JP) 2006-136358

(51) Int. Cl. G03G 15/20

(52) U.S. Cl. 399/33

(57) ABSTRACT

This invention can provide a fixing apparatus capable of determining its own life with high accuracy, and an image forming apparatus using this fixing apparatus. To accomplish this, a fixing apparatus includes a fixing unit whose nip portion is separable, a fixing driving motor which drives the fixing unit, a load detecting unit which detects the load acting on the fixing driving motor, and a determining unit which determines the life of the fixing unit on the basis of the difference between the load while the fixing unit is in a press-contacted state and the load while the fixing unit is in a separated state, which are detected by the load detecting unit.

### BACKGROUND OF THE INVENTION

1. Field of the Invention

The present invention relates to a fixing apparatus which fixes an image formed on a transfer material in an image forming apparatus.

2. Description of the Related Art

Conventionally, the user cannot check the load state of a fixing device which changes temporally. It is a common practice to replace the fixing device according to criteria a or b:
a for every predetermined number of sheets (or predetermined period of time) (Japanese Patent Laid-Open No. 2005-215599)
b at the time when the surface nature of a fixing belt (or roller) has deteriorated

The above-described prior art replaces the fixing device irrespective of the state of the fixing device at a relatively early stage to prevent the worst case scenario. This may increase the running cost. If the fixing device is not replaced at the relatively early stage, an unexpected load or a load on the fixing device due to temporal deterioration increases. This may deform or wear down a component (e.g., a gear).

### SUMMARY OF THE INVENTION

The present invention enables realization of a fixing apparatus capable of determining its own life with high accuracy, and an image forming apparatus using this fixing apparatus.

According to the present invention, the foregoing problem is solved by providing a fixing apparatus comprising:

a fixing unit whose nip portion is separable;

a fixing driving motor adapted to drive the fixing unit;

a load detecting unit adapted to detect a load acting on the fixing driving motor; and

a determining unit adapted to determine a life of the fixing unit on the basis of a difference between a load while the fixing unit is in a press-contacted state and a load while the fixing unit is in a separated state, which are detected by the load detecting unit.

Further features of the present invention will become apparent from the following description of exemplary embodiments with reference to the attached drawings.

### BRIEF DESCRIPTION OF THE DRAWINGS

FIG. 1 is a sectional view showing the schematic structure of a color copying machine according to the first embodiment;

FIG. 2 is a schematic view showing the press-contacted/separated state of a fixing unit;

FIG. 3 is a block diagram showing a fixing driving unit and detecting device according to the first embodiment;

FIG. 4 is a block diagram showing a current detecting circuit according to the first embodiment;

FIG. 5 is a graph showing the correlation between the detected current and the motor torque;

FIG. 6 is a graph showing the torque while the fixing unit is in press-contacted/separated state;

FIG. 7 is a graph showing a temporal change in torque in the fixing unit;

FIG. 8 is a graph showing a variation in torque due to an assembly error of the fixing unit; and

FIG. 9 is a flowchart showing a process for measuring the torque value to be used for life determination.

### DESCRIPTION OF THE EMBODIMENTS

A preferred embodiment of the present invention will now be described in detail with reference to the drawings. It should be noted that the relative arrangement of the components, the numerical expressions and numerical values set forth in these embodiments do not limit the scope of the present invention unless it is specifically stated otherwise.

A best mode for carrying out the present invention will be described in more detail below with reference to an embodiment of an electrophotographic color copying machine.

### First Embodiment

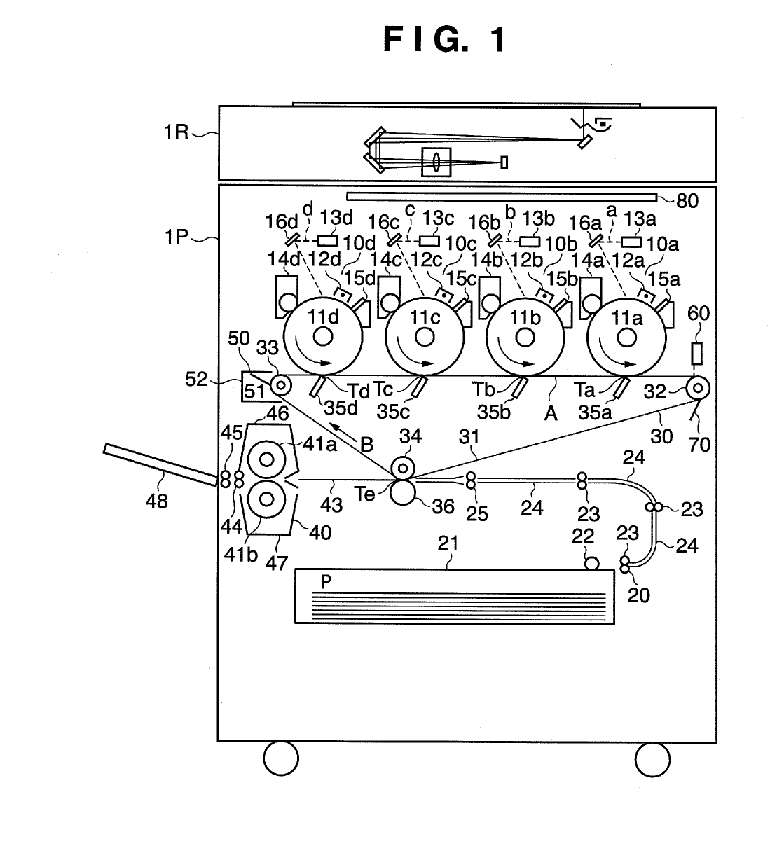

FIG. 1 is a schematic sectional view showing the overall structure of an “electrophotographic color copying machine” according to the first embodiment. The electrophotographic color copying machine (to be abbreviated as a “color copying machine” hereinafter) according to the first embodiment is a color image output apparatus to which the present invention is supposed to be effectively applied. The color image output apparatus adopts an intermediate transfer system and has a plurality of image forming units arranged in parallel.

The color copying machine according to the first embodiment comprises an image reading unit 1R and image output unit 1P. The image reading unit 1R optically reads the original images, converts them into electrical signals, and sends the converted electrical signals to the image output unit 1P. The image output unit 1P comprises a plurality of (e.g., four) juxtaposed image forming units 10, paper feed unit 20, intermediate transfer unit 30, fixing unit 40, cleaning units 50 and 70, photosensor 60, and control unit 80.

The individual units will be described in more detail. The image forming units 10, i.e., 10a, lob, 10c, and 10d have the same structure. The image forming units 10a, 10b, 10c, and 10d rotatably, axially support drum-shaped photosensitive bodies as first image carriers, i.e., photosensitive drums 11a, 11b, 11c, and 11d. The photosensitive drums 11a, 11b, 11c, and 11d are rotationally driven in the directions indicated by the arrows. Primary chargers 12, i.e., 12a to 12d, optical systems 13, i.e., 13a to 13d, return mirrors 16, i.e., 16a to 16d, and developing devices 14, i.e., 14a to 14d are arranged to oppose the outer circumferential surfaces of the photosensitive drums 11a to 11d along their rotation directions. Cleaning units 15, i.e., 15a to 15d are arranged next to the developing devices 14.

The primary chargers 12a to 12d uniformly charge the surfaces of the photosensitive drums 11a to 11d. The optical systems 13a to 13d expose the surfaces of the photosensitive drums 11a to 11d via the return mirrors 16a to 16d using light beams such as laser beams modulated in accordance with the recording image signals from the image reading unit 1R, thus forming electrostatic latent images on the photosensitive drums 11a to 11d.

Moreover, the developing units 14a to 14d which store corresponding developing materials (to be referred to as “toners” hereinafter) of four colors, i.e., yellow, cyan, magenta, and black visualize the electrostatic latent images. The visualized images are transferred onto image transfer areas Ta, Tb, Tc, and Td of a belt-shaped intermediate transfer member, i.e., intermediate transfer belt 31 serving as a secondary image carrier which forms the intermediate transfer unit 30.

On the downstream sides of the image transfer areas Ta, Tb, Tc, and Td, the cleaning units 15a, 15b, 15c, and 15d clean the surfaces of the photosensitive drums 11a to 11d by scraping the toners which remain on them without being transferred onto the intermediate transfer belt 31. With the above-described process, images are sequentially formed using respective toners.

The paper feed unit 20 comprises a cassette 21, pickup roller 22, paper feed roller pair 23, paper feed guide 24, and registration roller pair 25. The cassette 21 stores transfer materials P. The pickup roller 22 feeds the transfer materials P one by one from the cassette 21. The paper feed roller pair 23 further conveys the transfer materials P fed from the pickup roller 22. The registration roller pair 25 feeds the transfer materials P to a secondary transfer area Te while matching the image formation timings of the image forming units. Although a plurality of cassettes are used in practice, the following description assumes that only one cassette corresponding to the upper stage is used for convenience.

The intermediate transfer unit 30 will be described in detail next. The intermediate transfer belt 31 is wound around a driving roller 32, driven roller 33, and secondary transfer opposing roller 34 while being kept taut between them. The driving roller 32 transmits a driving force to the intermediate transfer belt 31. The driven roller 33 applies an appropriate tension to the intermediate transfer belt 31 by biasing a spring (not shown). A primary transfer plane A is formed between the driving roller 32 and the driven roller 33. The intermediate transfer belt 31 uses a material such as PET (polyethylene terephthalate) or PVDF (polyvinylidene fluoride). The metallic surface of the driving roller 32 is coated with rubber (urethane or chloroprene) having a thickness of several mm to prevent the driving roller 32 from slipping off the belt 31. A pulse motor (not shown) rotationally drives the driving roller 32.

In the primary transfer areas Ta to Td where the photosensitive drums 11a to 11d oppose the intermediate transfer belt 31, primary transfer chargers 35, i.e., 35a to 35d are arranged on the reverse side of the intermediate transfer belt 31. A secondary transfer roller 36 is arranged to oppose the secondary transfer opposing roller 34. The secondary transfer area Te is formed by nipping between the secondary transfer roller 36 and the intermediate transfer belt 31. The secondary transfer roller 36 is pressed against the intermediate transfer belt 31 with an appropriate pressure.

The cleaning unit 50 to clean the image formation surface of the intermediate transfer belt 31 is arranged downstream of the secondary transfer area Te of the intermediate transfer belt 31. The cleaning unit 50 comprises a cleaning blade 51 to remove the toner on the intermediate transfer belt 31, and a waste toner box 52 to store waste toner.

The driving roller 32 of the intermediate transfer belt 31 has a cleaning blade 70 and a pulse motor (not shown) to attach/detach the cleaning blade 70 to/from the intermediate transfer belt 31. The cleaning blade 70 is also used to remove the toner on the intermediate transfer belt 31.

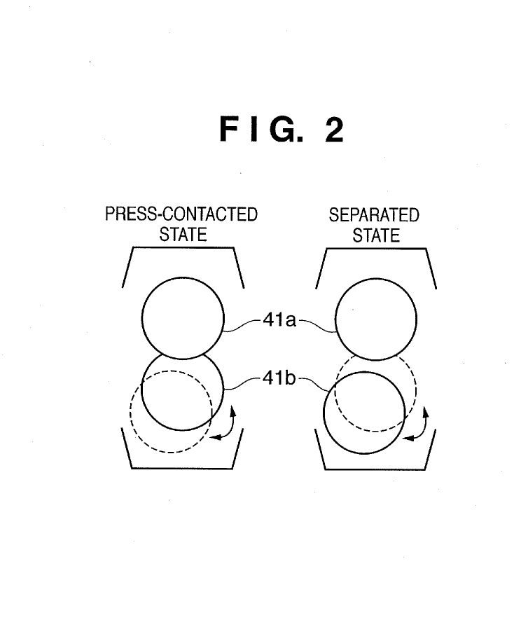

The fixing unit 40 comprises a fixing roller 41a and pressurizing roller 41b. The fixing roller 41a incorporates a heat source such as a halogen heater. The fixing roller 41b (which also incorporates a heat source in some cases) is pressed by the fixing roller 41a. A pressure release unit (not shown) can separate the fixing roller 41a and pressurizing roller 41b from their nip portion. As shown in FIG. 2, the state in which the fixing roller 41a and pressurizing roller 41b are spaced apart at their nip portion is defined as a separated state, while the state in which they are not spaced apart at their nip portion is defined as an press-contacted state. The fixing unit 40 also comprises a guide 43, fixing heat-insulating covers 46 and 47, internal paper discharge roller 44, external paper discharge roller 45, and paper discharge tray 48. The guide 43 guides a transfer material P to the nip portion between the pair of rollers 41a and 41b. The fixing heat-insulating covers 46 and 47 trap heat generated by the fixing unit 40 inside themselves. The internal paper discharge roller 44 and external paper discharge roller 45 further guide the transfer material P discharged from the pair of rollers 41a and 41b outside the apparatus. The paper discharge tray 48 stacks the transfer materials P.

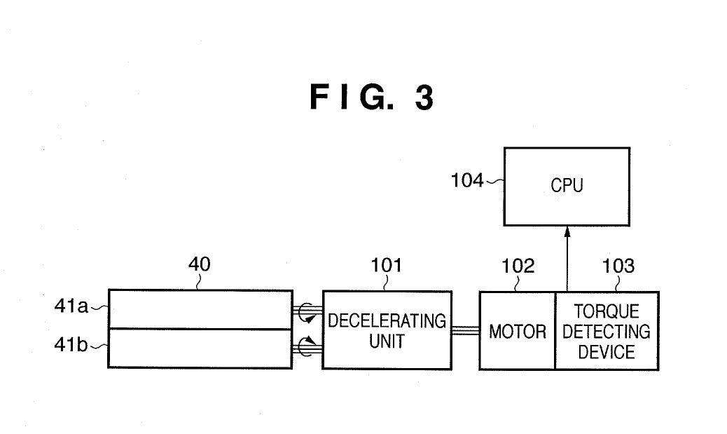

The operation of the color copying machine will be described next. When a CPU (FIG. 3) generates an image formation start signal, an operation for feeding transfer materials from the paper feed stage (in this case, the paper feed cassette 21) selected in accordance with the selected paper size starts.

Referring to FIG. 1, the pickup roller 22 feeds transfer materials P from the cassette 21 one by one. The transfer material P is guided through the paper feed guide 24 by the paper feed roller pair 23 and conveyed to the registration roller pair 25. At this time, the registration roller pair 25 is stopped and the leading end of the transfer material P abuts against the nip portion. Subsequently, the registration roller pair 25 starts rotation while matching the timing when the image forming units start image forming. The rotation timing of the registration roller pair 25 is set such that a transfer material P and a toner image primarily transferred onto the intermediate transfer belt 31 by the image forming units coincide with each other in the secondary transfer area Te.

When the CPU generates an image formation start signal, the image forming units operate in the following way. The toner image formed with the above-described process on the photosensitive drum 11d located on the most upstream side with respect to the rotation direction of the intermediate transfer belt 31 is primarily transferred onto the image transfer area Td of the intermediate transfer belt 31 by the primary transfer charger 35d to which a high voltage is applied. The primarily transferred toner image is conveyed to the next primary transfer area Tc. In the primary transfer area Tc, an image is formed with a time delay during which the toner image is conveyed among the image forming units. The next toner image is transferred by adjusting registration onto the previous image. By repeating the same process hereinafter, a four-color toner image is primarily transferred onto the intermediate transfer belt 31.

Subsequently, the transfer material P enters the secondary transfer area Te and comes into contact with the intermediate transfer belt 31. A high voltage is applied to the secondary transfer roller 36 while matching the timing when the transfer material P passes. The four-color toner image formed on the intermediate transfer belt 31 with the above-described process is transferred onto the surface of the transfer material P. After that, the convey guide 43 exactly guides the transfer material P to the nip portion of rollers 41a and 41b. The toner image is fixed to the surface of the transfer material P by heat from the pair of rollers 41a and 41b and pressure at their nip portion. The transfer material P is conveyed by the internal and external paper discharge rollers 44 and 45, discharged outside the apparatus, and stacked on the paper discharge tray 48.

FIG. 3 is a block diagram showing the fixing unit 40 and its driving unit according to the first embodiment. A fixing driving motor 102 drives the fixing unit 40 through a decelerating unit 101. Via an A/D converter (not shown) or the like as needed, a CPU 104 receives a signal from a torque detecting device (e.g., a driving current detecting device or torque converter) 103 inside or outside the fixing driving motor. The signal received by the CPU 104 from the torque detecting device 103 is converted into a torque value as needed. In this case, a prepared conversion table or the like is used.

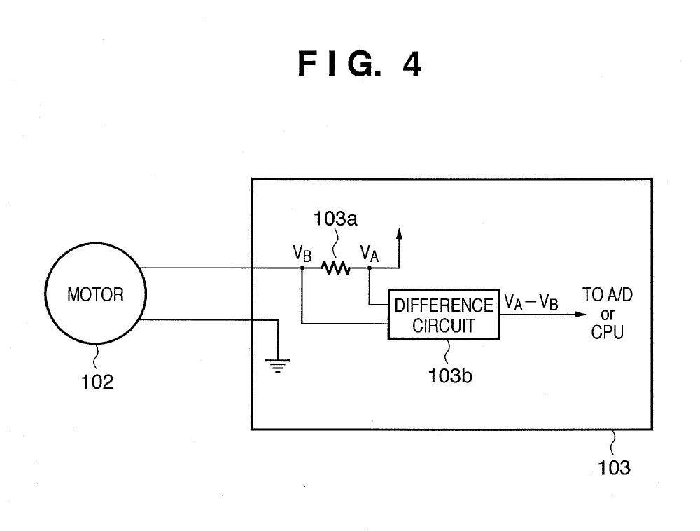

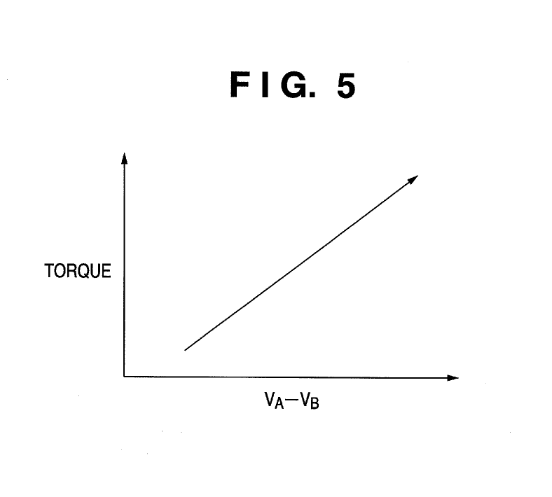

FIG. 4 shows a practical example of the torque detecting device. When a DC motor which consumes a current corresponding to torque is used for fixing driving, a current detection resistor 103a is serially connected to, e.g., the power supply line of the fixing driving motor 102 to detect a motor driving current. That is, a difference circuit 103b serving as a torque detecting device calculates a difference VA-VB between voltages VA and VB at the both ends of the current detection resistor 103a. Upon receiving the calculated difference, the CPU 104 can calculate the current supplied to the fixing driving motor 102. Also, the use of a graph (table) like the one shown in FIG. 5 representing the relationship between the detected voltage (detected current) and the torque makes it possible to easily detect the torque on the motor shaft.

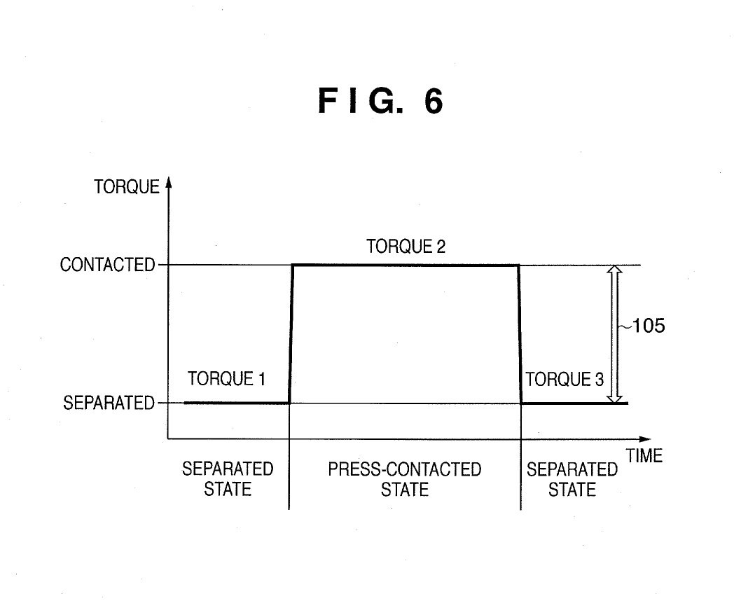

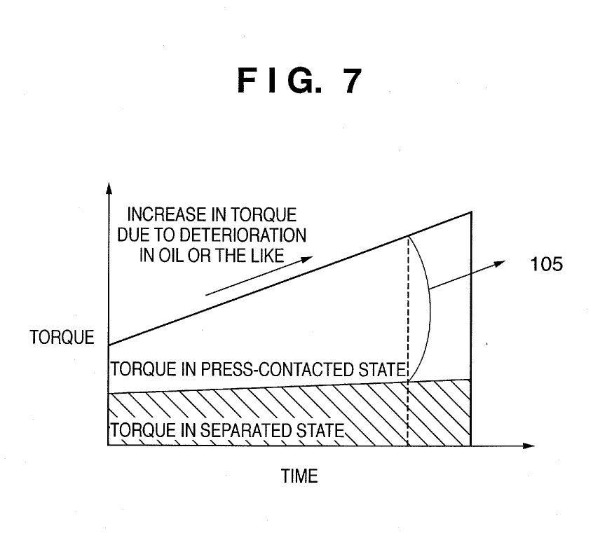

As described above, when a fixing device from which fixing rollers can be spaced apart is used, the torque while the fixing device is in the press-contacted state generally increases from the torque while the fixing device is in the separated state because the friction between the rollers or the like is added to the latter torque, as shown in FIG. 6. Furthermore, the friction force increases upon a temporal change (deterioration) in grease, oil, or the like, as shown in FIG. 7. This especially increases the torque upon press-contacted state. The torque upon separated state, which is detected by the fixing driving motor 102 changes (exhibits an individual difference) depending on, e.g., an assembly error of the fixing driving motor 102 or decelerating unit 101. However, since the change amount at this time is a loss due to the assembly error, the load acting on the gear or the like in the decelerating unit 101 has a low correlation with the change in torque of the fixing driving motor 102 due to the assembly error.

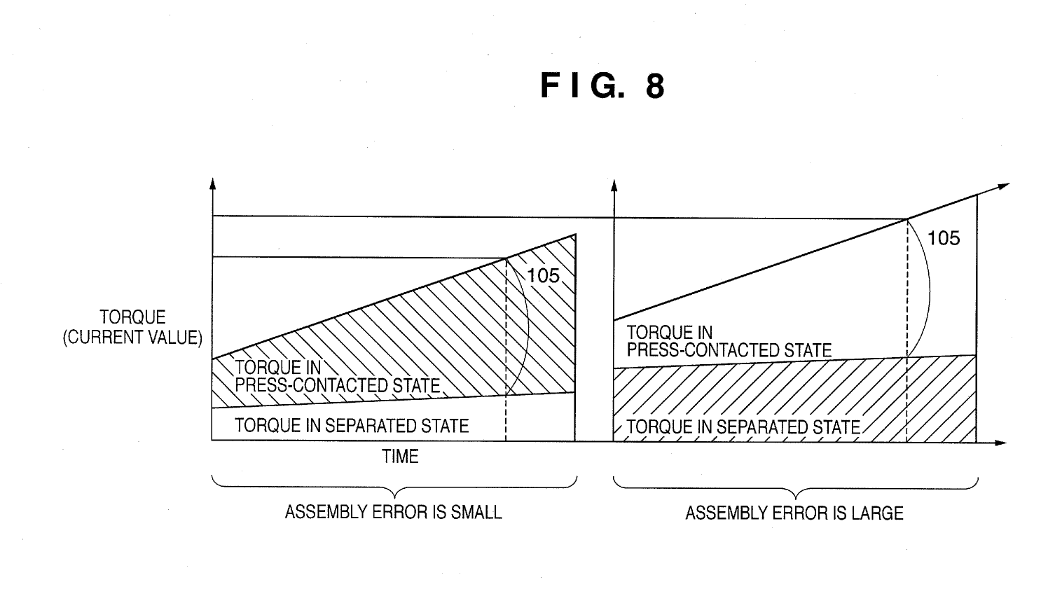

FIG. 8 shows an example when the torque while the fixing unit 40 is separated is small and an example when the torque while the fixing unit 40 is separated is large. That is, as shown in FIG. 8, getting a difference torque 105 between the torque while the fixing roller is press-contacted and the torque while the fixing roller is separated (to be referred to as a difference torque hereinafter) makes it possible to calculate the torque free from any assembly error, which acts upon driving the gear or the like in the decelerating unit 101. Comparison between the difference torque 105 and, e.g., the withstand load on the decelerating unit 101 or fixing device allows the user to grasp the state of the fixing unit 40.

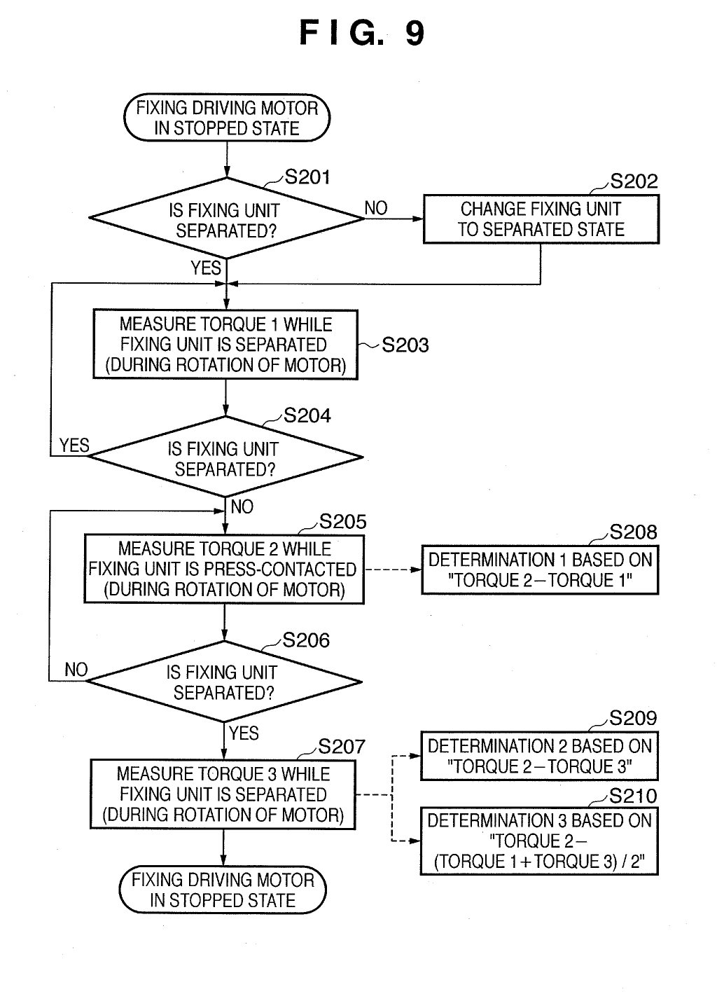

FIG. 9 is a flowchart showing a life determination process according to the present invention. The CPU 104 executes this process. First, when the power supply is turned off/on or while the fixing unit 40 is stopped after the JAM process or the like, the CPU 104 determines whether the fixing unit 40 is separated (see step 201; step will be abbreviated as S hereinafter). If the fixing unit 40 is not separated (NO in S201), it is separated at S202. When the fixing driving motor 102 starts rotation, the CPU 104 measures torque 1 in the separated state at S203. As the measurement of torque 1 starts, the CPU 104 determines whether the fixing unit 40 is separated at S204. If the fixing unit 40 is separated (YES in S204), the CPU 104 continues to measure torque 1. If the fixing unit 40 is press-contacted (NO in S204), the CPU 104 measures torque 2 in the press-contacted state during rotation of the fixing driving motor 102 at S205. As the measurement of torque 2 starts, the CPU 104 determines whether the fixing unit 40 is separated at S206. If the fixing unit 40 is press-contacted (NO in S206), the CPU 104 continues to measure torque 2. If the fixing unit 40 is separated (YES in S206), the CPU 104 measures torque 3 in the separated state during rotation of the fixing driving motor 102 at S207.

There are three determination points in this flowchart, and any one of them may be used to determine the life. The first determination point is based on a difference torque (S208) expressed by “torque 2-torque 1” as the fixing unit 40 changes from the separated state to the press-contacted state. The second determination point is based on a difference torque (S209) expressed by “torque 2-torque 3” as the fixing unit 40 changes from the press-contacted state to the separated state. The third determination point is based on a difference torque (S210) expressed by “a difference obtained by subtracting the average value of torque 1 and torque 3 in the separated state before and after torque 2 from torque 2” while the fixing unit 40 is press-contacted.

Although not shown in the flowchart, the following operations (a), (b) and (c) are preferable.

(a) To suppress a variation in torque upon passing paper, the torque is measured when no paper passes during rotation of the fixing driving motor 102.

(b) Each of torque 1, torque 2, and torque 3 is calculated as the average value of torque values obtained within a predetermined period of time, and stored in a memory.

(c) The torque of the motor is measured after its rotation stabilizes (after a predetermined period of time has elapsed from activation of the motor).

Although the first embodiment has been described using the fixing device having the two fixing rollers 41a and 41b, at least one of the fixing rollers 41a and 41b may be implemented as a belt. The first embodiment is applicable to general fixing devices from which fixing rollers can be spaced apart. Referring to FIG. 2, although the roller 41b moves to change the fixing unit 40 to the separated state, the roller 41a or both the rollers 41a and 41b may move.

As has been described above, according to the first embodiment, it is possible to calculate the load on the decelerating unit, free from any variation in torque due to an assembly error, by calculating the life of the fixing unit on the basis of the torque values while the fixing unit is separated and press-contacted. This makes it possible to determine the life with high accuracy. It is therefore possible to reduce the running cost and improve the reliability of products.

In the first embodiment, the fixing device from which the fixing rollers can be spaced apart detects an increase in fixing load upon press-contacted state due to a temporal change, and determines the state of the fixing device on the basis of the difference between the detected load and the load upon separated. This yields the following merits (a), (b) and (c).

(a) It is possible to protect a component such as a gear on which a large load acts upon driving by canceling an assembly error.

(b) It is possible to accurately determine the state of the fixing device independently of the status of the initial torque or the like.

(c) Input of special settings in replacement is unnecessary (the life load need not be determined on the basis of the initial load).

According to the present invention, it is possible to provide a fixing apparatus capable of determining its own life with high accuracy, and an image forming apparatus using this fixing apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-136358 filed on May 16, 2006, which is hereby incorporated by reference herein in its entirety.

What is claimed is:

1. A fixing apparatus comprising:
a fixing unit whose nip portion is separable;
a fixing driving motor adapted to drive said fixing unit;
a load detecting unit adapted to detect a load acting on said fixing driving motor; and
a determining unit adapted to determine a life of said fixing unit on the basis of a difference between a load while said fixing unit is in a press-contacted state and a load while said fixing unit is in a separated state, which are detected by said load detecting unit.

2. The fixing apparatus according to claim 1, wherein
said fixing driving motor is a DC motor, and
said load detecting unit detects a load acting on said fixing driving motor by a driving current of said DC motor.

3. The fixing apparatus according to claim 1, wherein said load detecting unit executes detection while at least one of condition from a condition in which no paper passes, a condition in which an average value of loads obtained within a predetermined period of time is calculated, and a condition in which rotation of said fixing driving motor has stabilized is satisfied.

4. An image forming apparatus comprising:
a fixing apparatus defined in claim 1.
